(19) United States
(12) Patent Application Publication
(10) Pub. No.: US 2019/0086440 A1
(43) Pub. Date: Mar. 21, 2019

(54) DIFFERENTIAL RING GEAR EQUIPPED WITH A TARGET FOR MEASURING THE ROTATION SPEED THEREOF AND ARRANGEMENT IN A GEAR BOX

(71) Applicant: Nissan Motor Co., Ltd., Yokohama-shi, Kanagawa (JP)

(72) Inventors: Laurent POMMIES, Marly Le Roi (FR); Paulo DA SILVA, Sartrouville (FR)

(21) Appl. No.: 16/082,975

(22) PCT Filed: Feb. 21, 2017
(86) PCT No.: PCT/FR2017/050384

§ 371 Date: Sep. 7, 2018

(30) Foreign Application Priority Data
Mar. 24, 2016 (FR) 1652549

(51) Int. Cl. G01P 3/488; F16H 48/38; B60K 17/16

(52) U.S. Cl. CPC G01P 3/488; F16H 2048/385; B60K 17/16; F16H 48/38

(57) ABSTRACT

A differential ring gear basically includes a plurality of gear teeth arranged along its outer radial periphery. The differential ring gear is provided with a measurement target for measuring a rotation speed of the differential ring gear. The measurement target is preferably configured as a ring having a plurality of circumferentially distributed teeth. The measurement target is arranged on a radially oriented side face of the differential ring gear.

### TECHNICAL FIELD OF THE INVENTION

The present invention concerns a differential ring gear of a motor vehicle transmission, the rotation speed of which is to be measured accurately and reliably.

The invention also concerns an arrangement, in a motor vehicle gearbox, for measuring the rotation speed of a differential ring gear.

### PRIOR ART

In order to use, and in particular control, a motor vehicle transmission, and in particular a gearbox belonging to such a transmission, it is necessary to have accurate information or data relative to the rotation speed of some of the components, such as, for example, a shaft of the gearbox and/or the ring gear of a differential belonging to such a transmission and that is, for example, at least partially incorporated into a gearbox.

Such needs exist in particular in the contexts of transmissions referred to as “hybrid” transmissions in which it is necessary to be able to accurately control different sources of heat and electrical power that are connected to a common transmission assembly.

It is particularly necessary to be able to control the torque and/or the rotation speed of these sources with a view to controlling changes to the transmission ratio.

Indeed, since such a type of hybrid transmission has no clutch, only a perfect synchronization of the rotation speeds, in particular of the gearbox shafts, can allow the different ratios or gears to shift in a reliable and high-quality manner, above all without jolting.

In order to have all of this accurate information on the rotation speeds of the different shafts in the gearbox or components fully or partially incorporated into the gearbox, using the association of pairs each comprising a “fixed” passage sensor and a target rotationally attached to the components whose rotation speeds are to be measured and that run past the sensor, is known.

Whatever detection technique is used by the sensor (optical, magnetic, etc.), the associated target is in the form of a set of circumferentially distributed teeth that is rotationally connected to the component whose rotation speed is to be measured.

A first sensor/target pair is, for example, associated with the shaft referred to as the connecting shaft, in order to provide information representative of the rotation speed of the connecting shaft and the primary shaft of the gearbox that are both in direct engagement and therefore representative of the rotation speed of the heat engine linked to the transmission.

Associating a second sensor/target pair at the differential is also known, in order to provide information representative of the rotation speed of the differential and the secondary shaft of the gearbox that are both in direct engagement, the secondary shaft being more specifically directly engaged with the ring gear of the differential.

Concerning this latter pair, the aim of which is to measure the rotation speeds of the ring gear of the differential (itself rotationally attached to the differential housing), the design and the installation of the target need to meet different requirements.

The measurement target needs to comprise a sufficient number of teeth to provide an accurate value for the speed of the differential, for example more than a hundred teeth.

The design and installation of the target must not have any impact on the function of lubricating the components of the gearbox and the differential as a whole.

The installation of the target also needs to allow the associated sensor to be installed inside the gearbox, and for example inside the gearbox housing.

Finally, the design, sizing and installation of the measurement target needs to allow the differential to also comprise a wheel referred to as a “parking” wheel on the differential housing that is capable of cooperating with an associated locking finger or with a shaft of the gearbox.

The invention aims to propose a design of the differential ring gear that is intended to satisfy the abovementioned technical requirements.

### BRIEF SUMMARY OF THE INVENTION

With this aim, the invention proposes a differential ring gear of a motor vehicle transmission, comprising gear teeth arranged at the outer radial periphery thereof, the ring gear being characterized in that it is equipped with a target for measuring the rotation speed of the ring gear, in the form of a ring comprising a plurality of circumferentially distributed teeth.

According to other features of the differential ring gear:
the measurement target is arranged in a radially oriented lateral face of the ring gear;
the ring gear comprises a peripheral annular body that comprises:
   the gear teeth; and
   a housing in which the measurement target is arranged;
the housing is produced by machining;
the housing is delimited by a concave, annular cylindrical face;
the measurement target is force fitted axially into the housing.

The invention also proposes an arrangement for measuring, in a motor vehicle gearbox, the rotation speed of a differential ring gear according to the invention, characterized in that it comprises a sensor that is fixed relative to a portion of the gearbox housing, and that is arranged facing the teeth of the measurement target.

According to other features of the arrangement:
the sensor is arranged axially opposite the teeth of the measurement target;
the sensor is arranged radially opposite the teeth of the measurement target.

### BRIEF DESCRIPTION OF THE FIGURES

Other features and advantages of the invention will become clearer on reading the detailed description that follows. In order to further improve understanding, reference is made to the appended drawings in which:

FIG. 1 is a schematic cross section view along a plane passing through the rotation shafts of the planet gears and the shafts of the sun gears of a differential of a motor vehicle transmission according to the prior art;

FIG. 2 is a schematic perspective view showing, in particular, a differential ring gear according to the invention equipped with a target for measuring its rotation speed associated with an axial reading measurement sensor;

FIG. 3 is a schematic cross section view similar to that of FIG. 1 showing the design and arrangement of the measurement target in association with the differential ring gear shown in FIG. 2; and

FIGS. 4 and 5 are views similar to those of FIGS. 3 and 4 that show a similar assembly in which the measurement target is associated with a radial reading sensor.

### DETAILED DESCRIPTION OF THE FIGURES

In the description that follows, which is provided as a non-limiting example, the same reference numbers will be used for identical or similar components.

In order to facilitate understanding of the description and claims, the terms vertical, lateral, transverse, horizontal, etc. will be used in reference to the trihedron L, V, T indicated in the figures, in a non-limiting manner and without reference to terrestrial gravity.

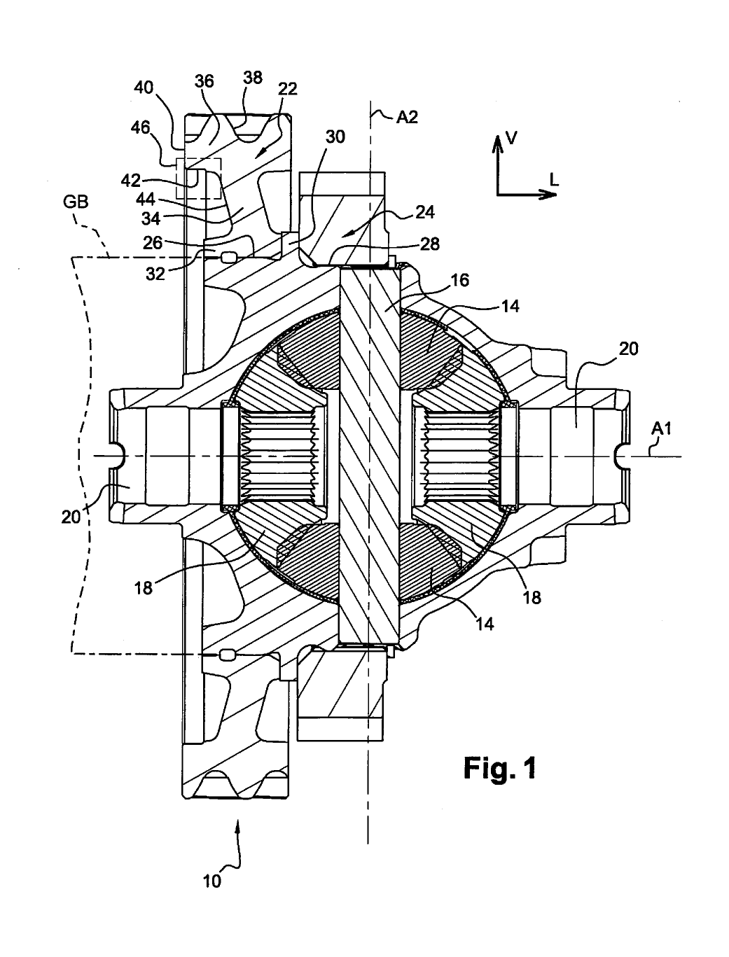

According to a known design of a differential 10 as shown schematically in FIG. 1, it consists of a differential housing 12 inside which planet gears 14 are mounted in rotation about a planet gear shaft 16 that is carried by the housing 12 in such a way that the planet gears 14 are mounted in rotation about a vertical geometric axis A2.

The differential housing 12 also houses sun gears 18, each of which is mounted on a horizontal shaft 20 to which it is rotatably attached, the shafts 20 being coaxial along a horizontal geometric axis A1 orthogonal to the axis A2.

The differential housing 12 is, for example, a part produced by foundry molding, the outer peripheral surface of which is in this case equipped with two additional components, arranged longitudinally from left to right with reference to FIG. 1: the differential housing 12 equipped with a peripheral differential ring gear 22, and a wheel referred to as the parking wheel 24.

The ring gear 22 and the wheel 24 are rotatably attached to the differential housing 12.

The ring gear 22 and the wheel 24 are each mounted on a convex cylindrical portion of axial orientation A1 and that is machined, 26 and 28 respectively.

The ring gear 22 and the wheel 24 are separated longitudinally by an outer radial shoulder 30 of the differential housing 12 that determines, in particular, the relative axial position of the ring gear 22 and the parking wheel 24 on the differential housing 12.

As is usually the case, the differential ring gear 12 is a metal part produced, for example, by forging, and it comprises, at its radially inner periphery, a cylindrical attachment lug 32 that is extended, radially outwards, by a web 34 of generally radial orientation.

Finally, the differential ring gear 22 comprises, at its radially outer periphery, a ring gear body 36 that is a peripheral annular body that comprises the gear teeth 38 allowing, in particular, the differential housing 12 to be rotatably attached with a transmission shaft such as an associated secondary shaft (not shown) of a gearbox (not shown).

The peripheral annular body 36 of the differential ring gear 22 is delimited axially in the longitudinal direction by a rear lateral face 40 that extends in a radial plane and by an inner concave cylindrical annular face 42.

The cylindrical face 42 is extended by a rear transverse face 44 of the web 34 that in this case has a frustoconical profile inclined relative to the radial plane.

In FIG. 1, a box with a dotted outline 46 indicates the available area of the differential ring gear 22 (and, more particularly, the body 36) in which, according to the invention and as will be explained in detail below, a target 50 may be installed for measuring the rotation speed of the differential ring gear 22.

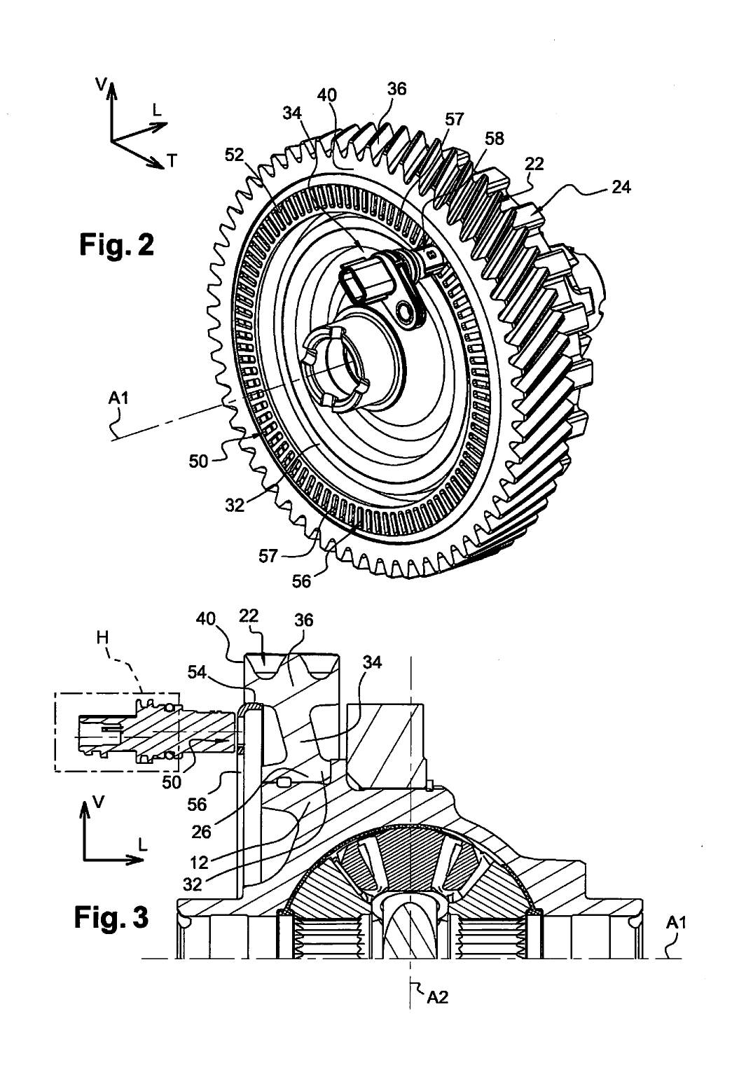

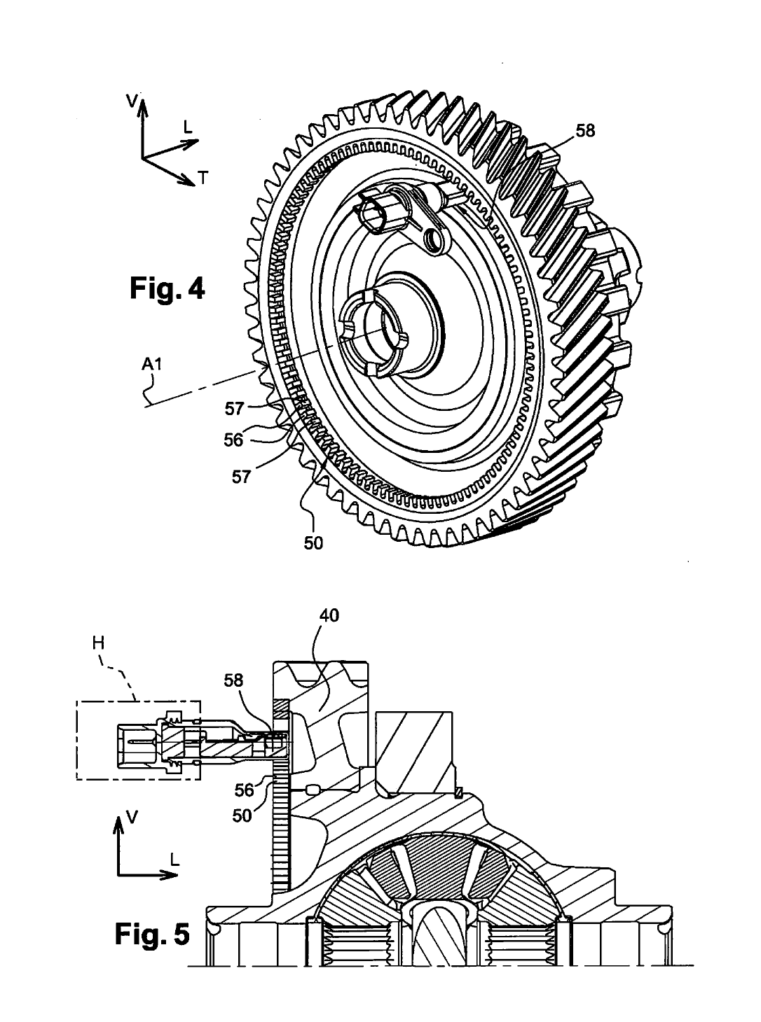

As shown in FIGS. 2 and 3, and similarly in FIGS. 4 and 5, the invention discloses the installation, on the differential ring gear 22, of a measurement target 50 that is generally ring-shaped and comprises a plurality of circumferentially distributed teeth.

According to the embodiments shown in FIGS. 2 to 5, the target 50 is arranged generally in the rear lateral face 40 of the peripheral annular body 36 of the differential ring gear 22.

To this end, in particular in order to allow its mounting and fixing by axial interlocking force, for example by shrink-fitting—while ensuring correct centering and preventing any unwanted deformation of the measurement target 50—the target 50 can be arranged in a complementary housing 52 produced by machining, in the area 46, a concave axial cylindrical face in the face 42 of the forged differential ring gear 22.

In order to mount, center and attach it on the annular body 36 of the differential ring gear 22, the target 50 can comprise a complementary part 54 in the form of an axial ferrule that extends longitudinally from the back towards the front.

In addition to the attachment and mounting ferrule 54, the target 50 in this case comprises a sequence of measurement teeth 56 that extend in a radial plane, radially towards the inside towards the axis A1, and that are in this case distributed circumferentially in a regular manner at a determined pitch.

The number of teeth 56 is, for example, greater than one hundred.

The teeth 56 are each delimited by a rear face 57, all of the faces 57 being situated substantially in the same radial plane.

In the embodiment shown in FIGS. 2 and 3, the target 50 rotation speed measurement is detected and read by means of an associated sensor 58 that is arranged longitudinally opposite the faces 57, i.e. the sensor 58 in this case takes an “axial” reading of the rotation of the target 50.

The sensor 58 is stationary relative to the rotating target 50 and is, for example, attached to a portion of the gearbox housing (not shown) relative to which the differential ring gear 22 rotates the measurement target 50 at the rotation speed of the differential housing 12.

In the second embodiment shown in FIGS. 4 and 5, the general design of the target 50 and its attachment and installation in the peripheral annular body 36 of the differential ring gear 22 are identical to those described and shown in reference to the first embodiment shown in FIGS. 2 and 3.

The measurement teeth 56 belonging to the measurement target 50 in this case extend generally radially and each is delimited by an inner radial face 57.

All the faces 57 extend generally in a same concave, annular cylindrical surface so as to allow, in this case, a reading referred to as a radial reading by means of the sensor 58, the active element of which extends in this case opposite the faces 57, being received radially “inside” the body of the differential ring gear 22 and inside the target 50.

The design according to the invention that has just been described is not limited to the embodiment and design examples of the target 50, in particular in the form of an element made from folded and cut sheet metal.

The target can be produced according to any known solution compatible with the type of sensor 58 associated with it.

1. A differential ring gear for a motor vehicle transmission, the differential ring gear comprising:
a peripheral annular ring gear body having a housing portion, and a plurality of gear teeth arranged at a radially outer periphery of the peripheral annular ring gear body; and
a measurement target disposed in the housing portion of the peripheral annular ring gear body, the measurement target being configured as a ring that includes a plurality of circumferentially distributed measurement teeth used for measuring a rotation speed of the differential ring gear.

2. The differential ring gear as claimed in claim 1, wherein
the measurement target is arranged in a radially oriented lateral face of the the peripheral annular ring gear body.

3. The differential ring gear as claimed in claim 1, wherein
the housing portion is a machined portion of the peripheral annular ring gear body.

4. The differential ring gear as claimed in claim 3, wherein
the housing portion is defined by an annular cylindrical face in a concaved recess of the peripheral annular ring gear body.

5. The differential ring gear as claimed in claim 1, wherein
the measurement target is force fitted axially into the housing portion.

6. The differential ring gear as claimed in claim 4, further comprising
a cylindrical attachment lug disposed radially inward of an inner periphery of the peripheral annular ring gear body, and
a web extending radially between the peripheral annular ring gear body and the cylindrical attachment lug, the web having a rear transverse face partially defining the concaved recess and the annular cylindrical face.

7. The differential ring gear as claimed in claim 1, wherein
the measurement target comprises an axially extending ferrule attached to the peripheral annular ring gear body.

8. The differential ring gear as claimed in claim 1, wherein
the measurement target comprises a sequence of measurement teeth that extend in a radial plane.

9. A differential ring gear measuring arrangement comprising the differential ring gear as claimed in claim 1, and the differential ring gear measuring arrangement further comprising:
a motor vehicle gearbox having a gearbox housing; and
a sensor fixed relative to a portion of the gearbox housing, and arranged to face the measurement teeth of the measurement target.

10. The differential ring gear measuring arrangement as claimed in claim 9, wherein
the sensor is arranged axially opposite the measurement teeth of the measurement target.

11. The differential ring gear measuring arrangement as claimed in claim 9, wherein
the sensor is arranged radially opposite the measurement teeth of the measurement target.
